(19) United States
(12) Patent Application Publication
(10) Pub. No.: US 2004/0064620 A1
(43) Pub. Date: Apr. 1, 2004

(54) Device representation apparatus and methods

(76) Inventors: Shivnandan D. Kaushik, Portland, OR (US); James B. Crossland, Banks, OR (US); Mohan J. Kumar, Aloha, OR (US); Linda J. Rankin, Portland, OR (US); David J. O'Shea, Costa Mesa, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/260,709

(22) Filed: Sep. 30, 2002

(51) Int. Cl. G06F 13/00

(52) U.S. Cl. 710/302

(57) ABSTRACT

An apparatus and system may include a peripheral device, such as an interrupt controller or Peripheral Component Interconnect (PCI) bridge device, having a memory-mapped legacy register and a PCI dummy register. The legacy register may be accessed by a Basic Input/Output System (BIOS) as part of a power-on initialization sequence for the peripheral device, and the dummy register may be accessed during a hot-plug operation using code executed by an Operating System (OS). An article, including a machine-accessible medium, may contain data capable of causing a machine to carry out a method of representing a peripheral device which includes identifying the peripheral device as a legacy device in a name space, such as an Advanced Configuration and Power Interface (ACPI) name space, and identifying the peripheral device as a dummy PCI device capable of being accessed during a hot-plug operation.

### BACKGROUND INFORMATION

As computers come to play an ever more prominent part in our daily lives, Reliability, Availability, and Serviceability (RAS) have become important factors to consider with respect to system performance. For this reason, support for hot-plug operations (i.e., wherein some part of an actively operating computer system platform can be removed and replaced with little or no degradation in overall operating performance) is being added to selected (typically high-end) computer systems.

### BRIEF DESCRIPTION OF THE DRAWINGS

FIG. 1 is a pseudo-coded method of representing a peripheral device according to an embodiment of the invention;

FIG. 2 is a block diagram of an apparatus, a system, and an article according to various embodiments of the invention; and

FIG. 3 is a flow diagram of a method of representing a peripheral device according to an embodiment of the invention.

### DETAILED DESCRIPTION OF EMBODIMENTS OF THE INVENTION

In the following detailed description of embodiments of the invention, reference is made to the accompanying drawings that form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to understand and implement them. Other embodiments may be utilized and derived therefrom, such that structural and logical substitutions and changes may be made without departing from the scope of the present disclosure. The following detailed description, therefore, is not to be taken in a limiting sense, and the scope of various embodiments of the invention is defined only by the appended claims, along with the full range of equivalents to which such claims are entitled.

After power is first applied to a computing platform (i.e., after power-on), some form of initialization operation or sequence typically occurs. During this time, most of the platform components, along with their associated devices, are addressed and initialized by the platform start-up code, such as Basic I/O System (BIOS) software.

When a hot-plug “hot-add” operation occurs, any component added to the operating platform also typically requires some attention with regard to initialization. However, since the platform BIOS is not in control of the platform during the hot-plug operation, device-specific code, provided by the BIOS, is typically executed by the OS to effect hot-plug initialization. For example, such an operational mechanism may be implemented using the Advanced Configuration and Power Interface (ACPI) Source Language (ASL), as defined in the ACPI Specification. Further information regarding ACPI and ASL may be obtained by referring to the ACPI Specification, Revision 2.0a, Mar. 31, 2002.

A particular example of hot-plug capability involves the use of an Intel® 82870 based server, one or more hot-pluggable Scalable Node Controllers (SNCs) and one or more I/O Hubs, such as Server I/O Hubs (SIOHs). When the components are involved in a hot-plug operation with respect to the server, all individual devices associated with the components are also involved in the operation. Thus, when a single SIOH is hot-replaced (e.g., a first SIOH is hot-removed, and then a second SIOH is hot-added), it typically means that two Intel P64H2 devices (i.e., PCI bridges) and one ICH2 (i.e., an I/O Controller Hub) are also hot-replaced.

Each P64H2 device may include two Intel® 82093AA I/O Advanced Programmable Interrupt Controllers (IOAPICs), which are typically exposed to the OS by the BIOS as a legacy device. As such, each IOAPIC is identified in the ACPI name space as a Microsoft® Windows® compatible device with a Plug and Play™ identifier of“PNP0003”, and not as a PCI device in the PCI bus hierarchy with an identifier of “interrupt controller”. For more information regarding the use of Plug and Play™ identifiers, refer to the ACPI Specification, Table 5-42.

Legacy devices initialized by the BIOS typically require ASL initialization during a hot-plug operation. Unfortunately, ASL-based hot-plug initialization can only be performed within the PCI configuration space, and this will not occur unless the device is represented as a PCI device. Currently available OSs are not able to view and support IOAPIC devices as PCI devices. In fact, currently available OSs ignore a PCI device having an “interrupt controller” identifier. The inability of the OS to treat the IOAPIC as both a legacy device and a PCI device prevents the use of hot-plug operations with components that include one or more IOAPICs, such as the SIOH.

Herein is described a new mechanism for identifying and representing a peripheral device, such as an interrupt controller, so that operational software is able to treat the peripheral device as a legacy device during power-on initialization, and as a PCI device for initialization operations immediately following a hot-plug operation. In one embodiment, this may be accomplished by identifying the peripheral device as both a legacy device and as a dummy PCI device.

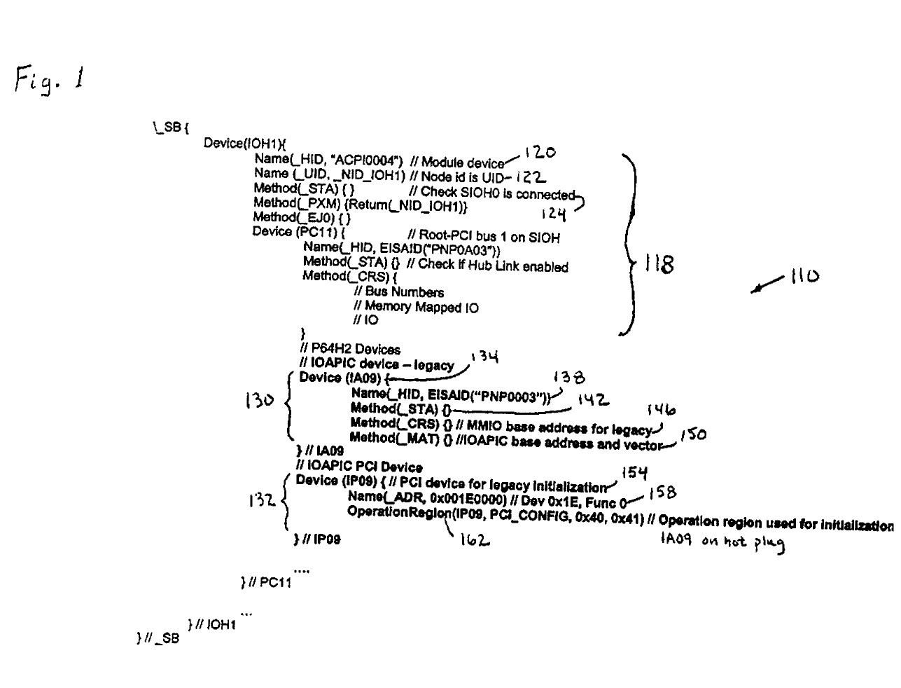

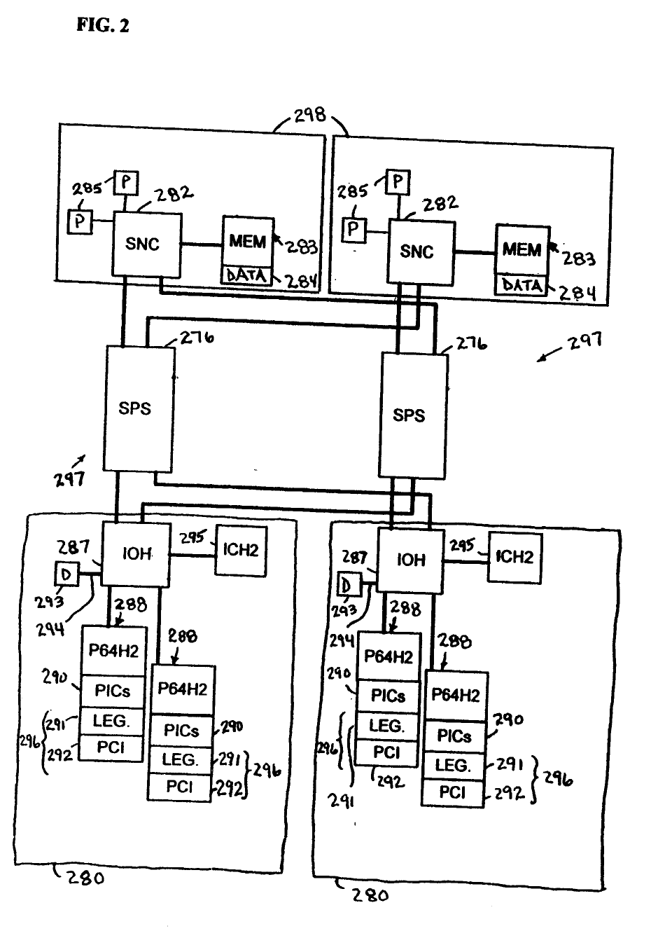

FIG. 1 is a pseudo-coded method of identifying a peripheral device according to an embodiment of the invention. In this example, assume that the peripheral device is an interrupt controller, similar to or identical to an IOAPIC (e.g., one of two IOAPICs forming part of a P64H2 device) which comprises part of a hot-pluggable I/O node that has an IOH, two P64H2 devices, and one ICH2 device. For reference purposes, the hot pluggable I/O node may be similar to or identical to the I/O node (i.e., element 280 shown in FIG. 2) described hereinafter. Reference may also be made to the ACPI Specification, Version 2.0a, Mar. 31, 2002 with regard to implementation details for some of the methods and objects described in FIG. 1.

The pseudo code of FIG. 1, which sets forth one example of a method 110 implementing an embodiment of the invention, includes an initialization portion 118. In line 120, the IOH that forms part of the hot-pluggable I/O node is associated with a module device, i.e., a container object that acts as a bus node in a namespace. Thus, a device named “IOHI” is created and, via the_HID object, the created device is associated with the Plug and Play™ identifier “ACPI0004”. Then, via the _UID object, the node identification is associated with the node's unique, persistent identification“_NID_IOH1” in line 122. The_STA method is then evaluated to ensure the IOH is connected in line 124.

The method 110 also has a legacy identification portion 130 wherein the IOAPIC device is identified as a legacy device, and a PCI identification portion 132 wherein the IOAPIC device is identified as a PCI device for access during hot-plug operations. In lines 134 and 138 a device “IA09” is created in the ACPI name space and associated with a Plug and Play™ identifier of “PNP0003” (which tells the OS that that this device is an interrupt controller). In line 142 the status of the device is checked, and then in line 146 the_CRS method is used to identify to the OS which resources (I/O, memory mapped address space, etc.) the device IA09 will be using. In line 150 the_MAT method is used to identify to the OS which base address will be used to operate the device, as well as to provide information about where in the platform (system) the interrupt controller (or other device) base vector is located. This is accomplished when the_MAT is evaluated to a buffer returning data in the format of a series of Multiple APIC Description Table (MADT) APIC Structure entries. The OS may need the latter information when there are multiple IOAPICs in the system. Thus, at the end of the legacy identification portion 130 of the pseudo code, the device IA09 exposes an IOAPIC, along with all the information needed to program and use the IOAPIC, to a legacy OS (one that does not address IOAPICs as PCI devices).

In the PCI identification portion 132 of the pseudo code, line 154, the start-up code (e.g., a BIOS) has created a device “IP09” in the ACPI name space. The IP09 device is a dummy PCI device used in the hot add process to program the IOAPIC for legacy operation. In line 158, the_ADR method provides information necessary for programming the device via the PCI programming mechanism. More specifically, the device number and function number of the ACPI component are provided so that the OS can use them for initializing/programming the device during hot-add operations. Thus, the ASL method executed during the hot-add operation (for programming the device as a legacy IOAPIC) is then able to access the device for initialization and programming via the PCI configuration space.

Since the ASL method is provided by the start-up code and interpreted/executed by the OS, the elements of the device which should be programmed, and the mechanisms for programming them, should be identified to the OS. The operation region, specified in line 162, provides this information. Thus, in this case, the OS receives information associating the IP09 with a specified region (e.g., a base address in the configuration space of 0×40, and a length of 0×41), and the IP09 device is identified as being of type “PCI_CONFIG”.

The ASL method that executes during a hot-add operation will now be able to refer to the specified operation region. For example, if a field named “RegA” is defined in the operation region (this would be done after the operation region definition for the device IP09 has been defined), and if this field needs to be set to a value of “1” during the hot-add operation in order to have the IOAPIC programmed to operate in legacy mode, then the ASL method that executes at hot-add time might use the following instruction expressed as an ASL method:

store (One, _SB.IOH1.EP09.REGA)

Using the pseudo code of FIG. 1, the OS may interpret this statement to mean that the IP09 is of the type PCI_CONFIG. Using the device information provided in the _ADR method (i.e., device 0×1e, function 0, and the offset for REGA from the base address in the IP09 configuration space), the correct register in the PCI configuration space of the IOAPIC can be programmed.

While a particular mixture of pseudo code and actual code have been used to illustrate the operation of the embodiment of the invention shown in FIG. 1, it is emphasized that other pseudo code and actual code implementations of the method illustrated in FIG. 1 may also be used, and they are included within the scope of various embodiments of the invention.

FIG. 2 is a block diagram of an apparatus, a system, and an article according to various embodiments of the invention. Interconnected switches 276 may be coupled to one or more I/O nodes 280, as well as Scalable Node Controllers (SNCs) 282, coupled in turn to memories 283 having data 284, as well as one or more processors 285. The I/O nodes 280 and the SNCs 282 may be hot-pluggable components.

The I/O node 280 may include an I/O Hub (IOH) 287, such as a Server I/O Hub (SIOH) 287 coupled to and/or including one or more hot-pluggable devices 288, including PCI bridge devices 288, similar to or identical to P64H2 devices, which in turn may include one or more interrupt controllers 290 (e.g., similar to or identical to an IOAPIC), each associated with or having a legacy register 291 and a PCI dummy register 292. The SIOH 287 may also be coupled to, and/or include a PCI device 293, perhaps by way of a PCI bus 294, as well as an ICH2 device 295.

In one embodiment, an apparatus 296 may include a memory-mapped legacy register 291, and a PCI dummy register 292, such as those included in the peripheral device 290. The legacy register 291, which may be located at the base address of an IOAPIC, for example, may be accessed by start-up code (e.g., a BIOS) as part of a power-on initialization operation or sequence for the peripheral device 290. The PCI dummy register 292 may be accessed during a hot-plug operation in association with a device in the PCI bus hierarchy, using code executable by an OS, such as code derived from the ASL.

In another embodiment, a system 297 may include an apparatus 296 having a peripheral device 290 (e.g., a device associated with or including a memory-mapped legacy register 291 and a PCI dummy register 292) and an IOH 287 capable of being communicatively coupled to the peripheral device 288. A hot-pluggable PCI device 293 may be communicatively coupled to the system 297, perhaps using the PCI bus 294. As noted above, the peripheral device 290 may be similar to or identical to an IOAPIC, or even a PCI bridge device 288, such as a P64H2 device.

The system may also include one or more SNCs 282 capable of being communicatively coupled to the IOH 287, perhaps using the switch 276. In addition, the SNCs 282 may be capable of hot-plug operation,

It should be noted that the switches 276, the memories 278, the nodes 280, the SNCs 282, the IOHs 287, the devices 288, the devices 290, registers 291, 292, the hot-pluggable devices 293, the ICH2 devices 295; the apparatus 296, and the systems 297 may all be characterized as “modules” herein. Such modules may include hardware circuitry, such as a microprocessor and/or memory circuits, software program modules, and/or firmware, and combinations thereof, as directed by the architect of the apparatus 296 and system 297, and appropriate for particular implementations of various embodiments of the invention.

The apparatus and systems of various embodiments of the present invention can be used in applications other than those involving interconnected servers and hot-pluggable I/O nodes, and thus, the invention is not to be so limited. The illustrations of an apparatus 296 and a system 297 are intended to provide a general understanding of the structure of various embodiments of the present invention, and are not intended to serve as a complete description of all the elements and features of apparatus and systems which might make use of the structures described herein.

Applications which may include the novel apparatus and systems of various embodiments of the present invention include electronic circuitry used in high-speed computers, communications and signal processing circuitry, processor modules, embedded processors, and application-specific modules, including multilayer, multi-chip modules. Such apparatus and systems may further be included as sub-components within a variety of electronic systems, such as televisions, video cameras, cellular telephones, personal computers, radios, vehicles, medical monitoring equipment, and others.

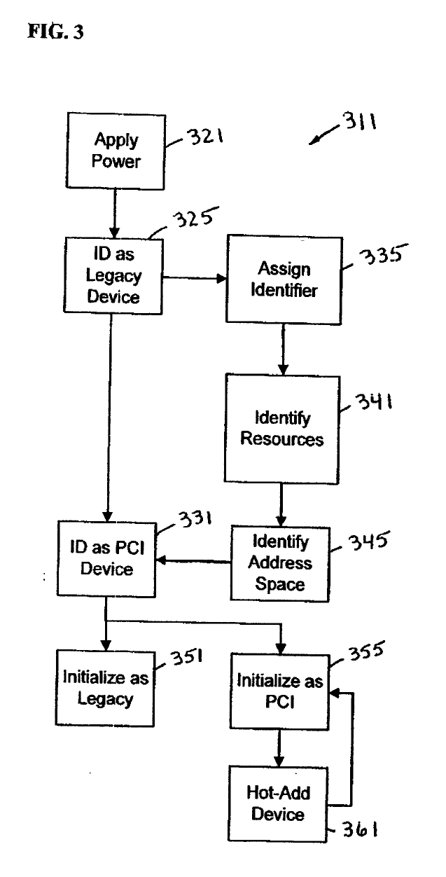

FIG. 3 is a flow diagram of a method of representing a peripheral device according to an embodiment of the invention. Generalizing from the pseudo code example shown in FIG. 1, the method 311 may begin with applying power to a computing platform, such as an I/O node, and a peripheral device, such as an interrupt controller (e.g., an IOAPIC) at block 321. The method may continue with identifying the peripheral device as a legacy device in a name space, such as an ACPI name space, at block 325. The method may include identifying the peripheral device as a peripheral component interconnect (PCI) device capable of being accessed during a hot-plug operation at block 331, which may in turn include creating an operational region for accessing the peripheral device as a PCI device during a hot-plug operation.

Identifying the peripheral device as a legacy device at block 325 may include associating the legacy device with a device identifier, such as a Plug and Play™ identifier, at block 335 (e.g. associating the identifier using the_HID object of the ACPI Specification), identifying resources required by the legacy device at block 341 (e.g., using the_CRS object of the ACPI Specification), and identifying an address space associated with the legacy device at block 345 (e.g., using the _MAT object of the ACPI specification).

Depending on the OS in use, for example, considering an OS which ignores PCI device descriptions, the peripheral device may be initialized as a legacy device at block 351. Alternatively, if the OS is compatible with PCI devices in general, the peripheral device may be initialized as a PCI device at block 355. If the device is hot-added to the platform at block 361, the device may again be initialized as a PCI device at block 355. Steps 361 and 355 may be repeated indefinitely.

It should be noted that while ACPI and ASL compatible program instructions have been used in some examples of representing peripheral devices herein, other mechanisms may also be used according to various embodiments of the invention, and therefore, the invention is not to be so limited. Therefore, it should be clear that some embodiments of the present invention may also be described in the context of computer-executable instructions, such as program modules, being executed by a computer. Generally, program modules may include routines, programs, objects, components, data structures, etc. that perform particular tasks or implement particular abstract data types.

Thus, referring back to FIG. 2, an article 298 according to an embodiment of the invention can be seen. One of ordinary skill in the art will understand, upon reading and comprehending this disclosure, the manner in which a software program can be launched from a computer-readable medium in a computer based system to execute the functions defined in such a software program. One of ordinary skill in the art will further understand the various programming languages which may be employed to create a software program designed to implement and perform the methods of the present invention. Such programs can be structured in an object-orientated format using an object-oriented language such as Java, Smalltalk, or C++. Alternatively, the programs can be structured in a procedure-orientated format using a procedural language, such as COBOL or C. The software components may communicate using any of a number of mechanisms that are well-known to those skilled in the art, such as Application Program Interfaces (APIs) or interprocess communication techniques. However, as will be appreciated by one of ordinary skill in the art upon reading this disclosure, the teachings of various embodiments of the present invention are not limited to any particular programming language or environment.

As is evident from the preceding description, a processor 285 typically accesses at least some form of computer-readable media, such as the memory 283. However, computer-readable and/or accessible media may be any available media that can be accessed by the processor 285, the apparatus 296, and/or the system 297.

By way of example and not limitation, computer-readable media may comprise computer storage media and communications media. Computer storage media includes volatile and non-volatile, removable and non-removable media implemented using any method or technology for storage of information such as computer-readable instructions, data structures, program modules or other data. Communication media specifically embodies computer-readable instructions, data structures, program modules or other data present in a modulated data signal such as a carrier wave, coded information signal, and/or other transport mechanism, which includes any information delivery media. The term “modulated data signal” means a signal that has one or more of its characteristics set or changed in such a manner as to encode information in the signal. By way of example and not limitation, communications media also includes wired media such as a wired network or direct-wired connections, and wireless media such as acoustic, optical, radio frequency, infrared and other wireless media. Combinations of any of the above are also included within the scope of computer-readable and/or accessible media.

Thus, referring to FIG. 2, it is now easily understood that another embodiment of the invention may include an article 298 comprising a machine-accessible medium 283 having associated data 284, wherein the data 284, when accessed, results in the machine 285 performing activities such as identifying a peripheral device as a legacy device in a name space, and identifying the peripheral device as a PCI device capable of being accessed during a hot-plug operation.

Other activities may include accessing the peripheral device as a legacy device using start-up code (e.g., a BIOS) during an initialization operation or sequence for an associated platform, or, after hot-adding the peripheral device included in an I/O node to the platform, for example, initializing the peripheral device as the PCI device using a code (e.g., ASL-derived code) executable by an OS.

Although specific embodiments have been illustrated and described herein, those of ordinary skill in the art will appreciate that any arrangement which is calculated to achieve the same purpose may be substituted for the specific embodiments shown. This disclosure is intended to cover any and all adaptations or variations of the invention. It is to be understood that the above description has been made in an illustrative fashion, and not a restrictive one. Combinations of the above embodiments, and other embodiments not specifically described herein will be apparent to those of skill in the art upon reviewing the above description. The scope of embodiments of the invention includes any other applications in which the above structures and methods are used. The scope of embodiments of the invention should be determined with reference to the appended claims, along with the full range of equivalents to which such claims are entitled.

It is emphasized that the Abstract of the Disclosure is provided to comply with 37 C.F.R. § 1.72(b) requiring an abstract that will allow the reader to quickly ascertain the nature of the technical disclosure. It is submitted with the understanding that it will not be used to interpret or limit the scope or meaning of the claims. In the foregoing Detailed Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

What is claimed is:

1. An apparatus, comprising:
a first register associated with a device, the first register to be accessed by start-up code as part of an initialization operation that treats the device as a legacy device; and
a second register associated with the device, the second register to be accessed during a hot-plug operation that treats the device as a peripheral component interconnect (PCI) device using code executed by an operating system.

2. The apparatus of claim 1, wherein the start-up code comprises a basic input/output system.

3. The apparatus of claim 1, wherein the device is included in a hot-pluggable input/output node.

4. The apparatus of claim 1, wherein the device is included in a hot-pluggable PCI bridge device.

5. The apparatus of claim 1, wherein the device is a device in a PCI bus hierarchy.

6. The apparatus of claim 5, wherein the device comprises an interrupt controller.

7. A system, comprising:
a device including a first register to be accessed by start-up code as part of an initialization operation that treats the device as a legacy device, and a second register to be accessed using code executed by an operating system that treats the device as a peripheral component interconnect (PCI) device during a hot-plug operation; and
an input/output hub capable of being communicatively coupled to the device.

8. The system of claim 7, further comprising:
a hot-pluggable device capable of being communicatively coupled to the device using a PCI bus.

9. The system of claim 7, wherein the first register is located at a base address for the device.

10. The system of claim 7, further comprising:
a node controller capable of being communicatively coupled to the input/output hub.

11. The system of claim 10, wherein the node controller is capable of hot-plug operation.

12. A method, comprising:
identifying a device as a legacy device in a name space; and
identifying the device as a peripheral component interconnect (PCI) device capable of being accessed during a hot-plug operation.

13. The method of claim 12, wherein identifying a device as a legacy device in a name space comprises:
associating the legacy device with a device identifier; and
identifying an address space associated with the legacy device.

14. The method of claim 12, wherein identifying a device as a legacy device in a name space comprises:
associating the legacy device with a device identifier; and
identifying resources required by the legacy device.

15. The method of claim 12, wherein the device is operatively coupled to a platform prior to a time when power is applied to the platform, further comprising:
applying power to the platform and the device; and
initializing the device as the legacy device.

16. The method of claim 12, further comprising:
hot-adding the device to a platform; and
initializing the device as the PCI device.

17. An article comprising a machine-accessible medium having associated data, wherein the data, when accessed, results in a machine performing:
identifying a device as a legacy device in a name space; and
identifying the device as a peripheral component interconnect (PCI) device capable of being accessed during a hot-plug operation.

18. The article of claim 17, wherein the machine-accessible medium further includes data, which when accessed by the machine, results in the machine performing:
accessing the device as a legacy device using a basic input/output system during an initialization sequence for a platform.

19. The article of claim 18, wherein the machine-accessible medium further includes data, which when accessed by the machine, results in the machine performing:
hot adding the device included in an input/output node to the platform; and
initializing the device as the PCI device using code executed by an operating system.

20. The article of claim 17, wherein the machine-accessible medium further includes data, which when accessed by the machine, results in the machine performing:
initializing the device using operating system executable code derived from a configuration and power interface language.

21. The article of claim 17, wherein identifying the device as a PCI device capable of being accessed during a hot-plug operation comprises:
creating an operational region for accessing the PCI device during the hot-plug operation.
